(19) United States
(12) Patent Application Publication
(10) Pub. No.: US 2024/0400064 A1
(43) Pub. Date: Dec. 5, 2024

(54) PREDICTION ACCURACY EVALUATION METHOD AND PREDICTION ACCURACY EVALUATION SYSTEM

(71) Applicant: TOYOTA JIDOSHA KABUSHIKI KAISHA, Toyota-shi (JP)

(72) Inventors: Yusuke HAYASHI, Susono-shi (JP); Taichi Kawanai, Susono-shi (JP); Sadayuki Abe, Sunto-gun (JP); Daichi Hotta, Meguro-ku (JP); Hiroshi Sakamoto, Susono-shi (JP)

(73) Assignee: TOYOTA JIDOSHA KABUSHIKI KAISHA, Toyota-shi (JP)

(21) Appl. No.: 18/624,809

(22) Filed: Apr. 2, 2024

(30) Foreign Application Priority Data
Jun. 1, 2023 (JP) 2023-091083

(51) Int. Cl. B60W 50/00; B60W 50/02

(52) U.S. Cl. CPC B60W 50/0097; B60W 50/0205; B60W 2050/0215

(57) ABSTRACT

A prediction accuracy evaluation method is executed by a computer. The prediction accuracy evaluation method includes a process of acquiring detection information. The detection information indicates a detected position, a detected velocity, an error range of the detected position, and an error range of the detected velocity of an obstacle detected by using a sensor mounted on a moving body. The prediction accuracy evaluation method further includes: a predicted distribution generation process that generates a predicted distribution of a position of the obstacle at a second time later than a first time, based on first detection information that is the detection information at the first time; and a prediction abnormality determination process that determines whether or not the predicted distribution is abnormal based on the predicted distribution and a second detected position that is the detected position of the obstacle at the second time.

### CROSS-REFERENCES TO RELATED APPLICATION

The present disclosure claims priority to Japanese Patent Application No. 2023-091083, filed on Jun. 1, 2023, the contents of which application are incorporated herein by reference in their entirety.

### TECHNICAL FIELD

The present disclosure relates to a technique for evaluating prediction accuracy of a future position of an obstacle detected by using a sensor mounted on a moving body.

### BACKGROUND ART

Patent Literature 1 discloses a system for controlling a vehicle. The system detects an object around the vehicle by the use of an in-vehicle sensor. Further, the system predicts a future behavior of the detected object based on past object behavior data at the detection position. Then, the system sets a control plan of automated driving based on the predicted future behavior of the detected object.

### LIST OF RELATED ART

Patent Literature 1: Japanese Patent No. 6051162

### SUMMARY

According to the technique described in the Patent Literature 1, the future behavior of the object detected by the use of the in-vehicle sensor is predicted. However, when accuracy of the prediction is low, accuracy of the automated driving control based on the result of the prediction also decreases.

An object of the present disclosure is to provide a technique capable of evaluating prediction accuracy of a future position of an obstacle detected by using a sensor mounted on a moving body.

A first aspect is directed to a prediction accuracy evaluation method executed by a computer.

The prediction accuracy evaluation method includes:
acquiring detection information indicating a detected position, a detected velocity, an error range of the detected position, and an error range of the detected velocity of an obstacle detected by using a sensor mounted on a moving body;
a predicted distribution generation process that generates a predicted distribution of a position of the obstacle at a second time later than a first time, based on first detection information that is the detection information at the first time; and
a prediction abnormality determination process that determines whether or not the predicted distribution is abnormal based on the predicted distribution and a second detected position that is the detected position of the obstacle at the second time.

A second aspect is directed to a prediction accuracy evaluation system.

The prediction accuracy evaluation system includes one or more processors.

The one or more processors acquire detection information indicating a detected position, a detected velocity, an error range of the detected position, and an error range of the detected velocity of an obstacle detected by using a sensor mounted on a moving body.

The one or more processors execute a predicted distribution generation process that generates a predicted distribution of a position of the obstacle at a second time later than a first time, based on first detection information that is the detection information at the first time.

The one or more processors execute a prediction abnormality determination process that determines whether or not the predicted distribution is abnormal based on the predicted distribution and a second detected position that is the detected position of the obstacle at the second time.

According to the present disclosure, it is possible to evaluate the prediction accuracy of the future position of the obstacle detected by using the sensor mounted on the moving body. In particular, according to the present disclosure, the predicted distribution of the position of the obstacle at the second time later than the first time is generated on the basis of the first detection information at the first time. Then, whether or not the predicted distribution is abnormal is determined based on the predicted distribution and the second detected position of the obstacle at the second time. Considering not only a simple predicted position but also the predicted distribution makes it possible to evaluate the prediction accuracy with higher accuracy.

### BRIEF DESCRIPTION OF DRAWINGS

FIG. 1 is a conceptual diagram for explaining an overview of an embodiment;

FIG. 2 is a block diagram showing an example of a functional configuration of a prediction accuracy evaluation system;

FIG. 3 is a flow chart showing a prediction accuracy evaluation process;

FIG. 4 is a conceptual diagram for explaining an example of a predicted distribution generation process;

FIG. 5 is a conceptual diagram for explaining a prediction accuracy calculation process and a prediction abnormality determination process; and

FIG. 6 is a block diagram for explaining application examples of the prediction accuracy evaluation system.

### DETAILED DESCRIPTION

### 1. Overview

The technique according to the present embodiment is applied to a moving body. Examples of the moving body include a vehicle, a robot, and the like. The vehicle may be an automated driving vehicle or a vehicle driven by a driver. Examples of the robot include a distribution robot, a work robot, and the like. As an example, in the following description, a case where the moving body is a vehicle will be considered. In a case of generalization, “vehicle” in the following description shall be replaced with “moving body.”

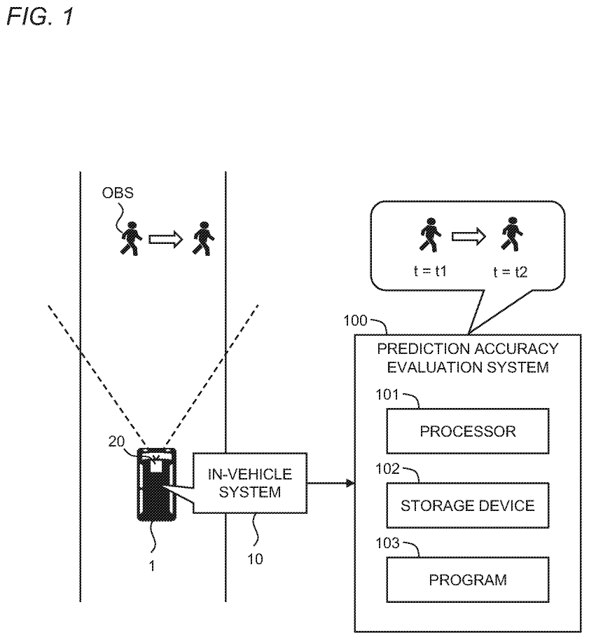

FIG. 1 is a conceptual diagram for explaining an overview of the present embodiment. An in-vehicle system 10 is mounted on a vehicle 1 and controls the vehicle 1. The in-vehicle system 10 may be an automated driving system that controls the automated driving of the vehicle 1. That is, the vehicle 1 may be an automated driving vehicle. Here, the automated driving means that at least a part of steering, acceleration, and deceleration of the vehicle 1 is automatically performed independently of a driving operation of a driver. As an example, the automated driving may be one of Level 3 or higher.

A sensor 20 is mounted on the vehicle 1. The sensor 20 includes a recognition sensor, a vehicle state sensor, a position sensor, and the like. The recognition sensor is used for recognizing (detecting) a situation around the vehicle 1. Examples of the recognition sensor include a camera, a laser imaging detection and ranging (LIDAR), a radar, and the like. The vehicle state sensor detects a state of the vehicle 1. For example, the vehicle state sensor includes a velocity sensor, an acceleration sensor, a yaw rate sensor, a steering angle sensor, and the like. The position sensor detects a position and an orientation of the vehicle 1. For example, the position sensor includes a global navigation satellite system (GNSS) sensor.

The in-vehicle system 10 detects (recognizes) an object around the vehicle 1 by the use of the recognition sensor. Examples of the object around the vehicle 1 include an obstacle OBS, a white line, a landmark, a traffic light, and the like. Examples of the obstacle OBS include a pedestrian, a bicycle, a two wheeled vehicle, another vehicle (for example, a preceding vehicle, a parked vehicle, or the like), a fallen object, and the like. Object information indicates a relative position and a relative velocity of the detected object with respect to the vehicle 1. For example, analyzing an image captured by a camera makes it possible to recognize an object and to calculate the relative position of the object. It is also possible to recognize an object and acquire the relative position and the relative velocity of the object based on the point group information obtained by the LIDAR.

In addition, the in-vehicle system 10 acquires vehicle position information indicating a current position of the vehicle 1 by the use of the position sensor. The in-vehicle system 10 may acquire highly accurate vehicle position information by a commonly known localization process using the object information and the map information. Further, the in-vehicle system 10 acquires vehicle state information detected by the vehicle state sensor.

The in-vehicle system 10 controls the vehicle 1 based on a variety of information obtained by the sensor 20. For example, the in-vehicle system 10 automatically performs risk avoidance control for avoiding the obstacle OBS in front of the vehicle 1. The risk avoidance control is an example of the automated driving control and includes at least one of steering control and deceleration control. More specifically, the in-vehicle system 10 generates a target trajectory for avoiding a collision with the detected obstacle OBS. The target trajectory includes a target position and a target velocity of the vehicle 1. Then, the in-vehicle system 10 performs vehicle travel control so that the vehicle 1 follows the target trajectory.

In order to improve the accuracy of the vehicle control (e.g., the risk avoidance control) related to the obstacle OBS, it is desirable to accurately predict a future position of the detected obstacle OBS. The in-vehicle system 10 acquires detection information regarding the obstacle OBS detected by using the sensor 20 (the recognition sensor). Further, the in-vehicle system 10 predicts a future position of the obstacle OBS based on the detection information of the obstacle OBS and a predetermined prediction algorithm. Then, the in-vehicle system 10 performs the vehicle control in consideration of the predicted future position of the obstacle OBS.

However, when the prediction accuracy of the future position of the obstacle OBS is low, the accuracy of the vehicle control based on the result of the prediction also decreases. In view of the above, the present embodiment proposes a technique capable of evaluating the prediction accuracy of the future position of the obstacle OBS. A process of evaluating the prediction accuracy of the future position of the obstacle OBS detected by using the sensor 20 (the recognition sensor) mounted on the vehicle 1 is hereinafter referred to as a “prediction accuracy evaluation process.”

A prediction accuracy evaluation system 100 is configured to perform the prediction accuracy evaluation process. For example, the prediction accuracy evaluation system 100 is a part of the in-vehicle system 10 described above. In other words, the prediction accuracy evaluation system 100 may be included in the in-vehicle system 10. The prediction accuracy evaluation system 100 may perform the prediction accuracy evaluation process in real time in conjunction with the prediction process performed by the in-vehicle system 10.

As another example, the prediction accuracy evaluation system 100 may be disposed outside the vehicle 1. In this case, the prediction accuracy evaluation system 100 communicates with the vehicle 1 (the in-vehicle system 10) and acquires information necessary for the prediction accuracy evaluation process from the in-vehicle system 10. For example, the necessary information includes sensor data obtained by the sensor 20. As another example, the necessary information may include the detection information indicating the result of the detection of the obstacle OBS detected based on the sensor data. As still another example, the necessary information may include the result of the prediction of the future position of the obstacle OBS predicted by the in-vehicle system 10. The prediction accuracy evaluation system 100 may perform the prediction accuracy evaluation process in real time in conjunction with the prediction process performed by the in-vehicle system 10. Alternatively, the prediction accuracy evaluation system 100 may accumulate the detection information of the obstacle OBS and perform the prediction accuracy evaluation process offline. The prediction accuracy evaluation system 100 outside the vehicle 1 may have the same function as the in-vehicle system 10.

As still another example, the prediction accuracy evaluation system 100 may be distributed to the in-vehicle system 10 and an external management server.

When generalizing, the prediction accuracy evaluation system 100 includes one or more processors 101 (hereinafter, simply referred to as a processor 101 or processing circuitry) and one or more storage devices 102 (hereinafter, simply referred to as a storage device 102). The processor 101 executes a variety of processing including the prediction accuracy evaluation process. Examples of the processor 101 include a central processing unit (CPU), an application specific integrated circuit (ASIC), a field-programmable gate array (FPGA), and the like. The storage device 102 stores a variety of information necessary for the processing by the processor 101. Examples of the storage device 102 include a hard disk drive (HDD), a solid state drive (SSD), a volatile memory, a non-volatile memory, and the like.

A program 103 is a computer program for controlling the prediction accuracy evaluation system 100. The functions of the prediction accuracy evaluation system 100 may be implemented by a cooperation of the processor 101 executing the program 103 and the storage device 102. The program 103 is stored in the storage device 102. The program 103 may be recorded on a non-transitory computer-readable recording medium.

Hereinafter, the prediction accuracy evaluation process performed by the prediction accuracy evaluation system 100 according to the present embodiment will be described in more detail.

### 2. Prediction Accuracy Evaluation Process

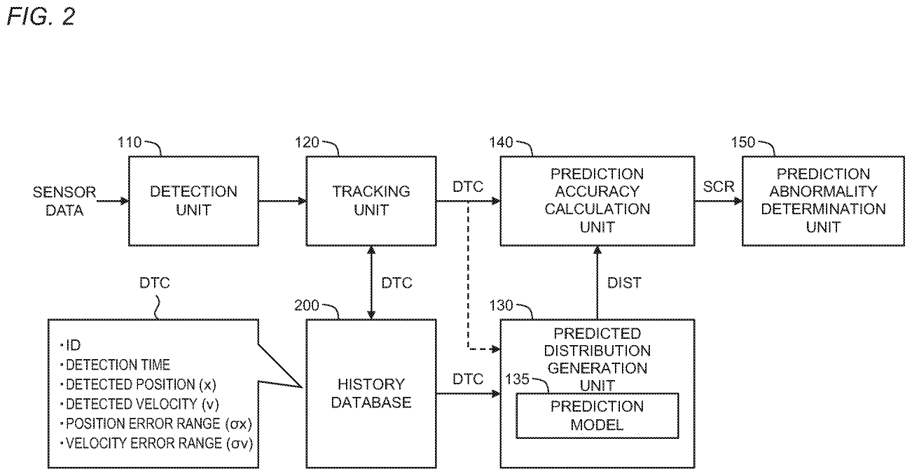

FIG. 2 is a block diagram showing an example of a functional configuration of the prediction accuracy evaluation system 100 according to the present embodiment. The prediction accuracy evaluation system 100 includes, as functional blocks, a detection unit 110, a tracking unit 120, a predicted distribution generation unit 130, a prediction accuracy calculation unit 140, and a prediction abnormality determination unit 150. These functional blocks may be implemented by a cooperation of the processor 101 and the storage device 102. Moreover, the prediction accuracy evaluation system 100 includes a history database 200 described later. The history database 200 is stored in the storage device 102.

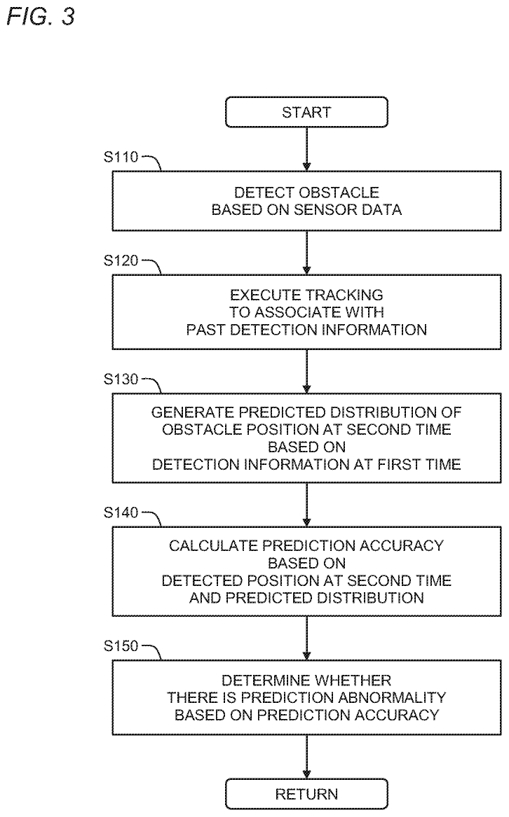

FIG. 3 is a flowchart showing the prediction accuracy evaluation process. The prediction accuracy evaluation process according to the present embodiment will be described with reference to FIGS. 2 and 3.

### 2-1. Detection Process (Step S110)

The detection unit 110 detects an obstacle OBS around the vehicle 1 based on the sensor data obtained by the sensor 20 (the recognition sensor) mounted on the vehicle 1. Examples of the obstacle OBS include a pedestrian, a bicycle, a two wheeled vehicle, another vehicle (for example, a preceding vehicle, a parked vehicle, and the like), a fallen object, and the like. For example, analyzing an image captured by the camera makes it possible to detect and recognize an obstacle OBS shown in the image. Typically, an image recognition AI, which is generated in advance through machine learning, is used for the detection and recognition of the obstacle OBS. As another example, the obstacle OBS can be detected and recognized based on the point group information obtained by the LIDAR. It is also possible to detect the obstacle OBS by combining the camera and other recognition sensors (fusion).

### 2-2. Tracking Process (Step S120)

The tracking unit 120 performs tracking of the obstacle OBS detected by the detection unit 110. By this tracking process, the obstacle OBS detected this time is associated with the same obstacle OBS detected in the previous time. In other words, the same obstacle OBS detected at different timings are associated with each other. The tracking process is a well-known technique, and the method thereof is not particularly limited. For example, a machine learning based tracking algorithm is used. A Kalman filter may be used. The ByteTrack may be used for the tracking process.

The detection information DTC is information regarding the detected obstacle OBS. For example, the detection information DTC includes identification information (ID), a detection time, a detected position x, a detected velocity v, a position error range σx, and a velocity error range σv.

The identification information is information for identifying the same obstacle OBS. The same identification information is given to the same obstacle OBS, and different identification information is given to different obstacles OBS. For example, a track ID assigned to the same obstacle OBS in the tracking process may be used as the identification information of the obstacle OBS.

The detection time is a time (processing cycle) at which the obstacle OBS is detected. The detection time is obtained from the detection unit 110 or the tracking unit 120.

The detected position x is the position of the obstacle OBS in the absolute coordinate system. The relative position of the obstacle OBS with respect to the vehicle 1 is obtained by the detection unit 110. The position of the vehicle 1 in the absolute coordinate system is obtained from the vehicle position information described above. By combining the relative position of the obstacle OBS and the position of the vehicle 1 in the absolute coordinate system, the detected position x of the obstacle OBS in the absolute coordinate system can be calculated. Alternatively, the detected position x of the obstacle OBS may be calculated from the result of the tracking process by the tracking unit 120.

The position error range σx is a parameter representing an error range of the detected position x of the obstacle OBS. The position error range σx can also be said to be a confidence interval of the detected position x of the obstacle OBS. For example, when the detected position x of the obstacle OBS is represented by a normal distribution, the position error range σx (confidence interval) is set based on the standard deviation of the normal distribution. Such a position error range σx depends on the object detection algorithm and is obtained from the detection unit 110. Alternatively, the position error range σx depends on the tracking algorithm and is obtained from the tracking unit 120.

The position error range σx may be variably set according to the type of the obstacle OBS. For example, in a case where the obstacle OBS is a pedestrian, the position detection accuracy is considered to be high because its volume is small. Therefore, the position error range σx in the case of the pedestrian may be set to be smaller than that in a case of a vehicle.

The detected velocity v is the velocity of the obstacle OBS in the absolute coordinate system. The relative velocity of the obstacle OBS with respect to the vehicle 1 is obtained by the detection unit 110 or the tracking unit 120. The velocity and the direction of travel of the vehicle 1 in the absolute coordinate system are obtained from the vehicle position information and the vehicle state information described above. Combining the relative velocity of the obstacle OBS and the velocity and the direction of travel of the vehicle 1 in the absolute coordinate system makes it possible to calculate the detected velocity v of the obstacle OBS in the absolute coordinate system.

The velocity error range σv is a parameter representing an error range of the detected velocity v of the obstacle OBS. The velocity error range σv can also be said to be a confidence interval of the detected velocity v of the obstacle OBS. For example, when the detected velocity v of the obstacle OBS is represented by a normal distribution, the velocity error range σv (confidence interval) is set based on the standard deviation of the normal distribution. Such a velocity error range σv depends on the object detection algorithm and is obtained from the detection unit 110. Alternatively, the velocity error range σv depends on the tracking algorithm and is obtained from the tracking unit 120.

The velocity error range σv may be variably set according to the type of the obstacle OBS. For example, in a case where the obstacle OBS is a pedestrian, there is a possibility that more rapid acceleration occurs as compared with a case of a vehicle. Therefore, the velocity error range σv in the case of the pedestrian may be set to be larger than that in the case of the vehicle.

The history database 200 is a database of the detection information DTC obtained in the past. When the tracking unit 120 acquires new detection information DTC by the tracking process, the tracking unit 120 registers the new detection information DTC in the history database 200. In the next processing cycle, the tracking unit 120 receives the latest detection result regarding the obstacle OBS from the detection unit 110. When the latest detection result is received, the tracking unit 120 performs the tracking process based on the past detection information DTC registered in the history database 200. As a result of the tracking process, the obstacle OBS detected this time is associated with the same obstacle OBS detected in the previous time. That is to say, the obstacle OBS detected this time is associated with the past detection information DTC registered in the history database 200. The tracking unit 120 registers new detection information DTC regarding the obstacle OBS detected this time in the history database 200.

In this manner, the detection information DTC regarding the same obstacle OBS is accumulated in the history database 200.

### 2-3. Predicted Distribution Generation Process (Step S130)

The predicted distribution generation unit 130 predicts a position of the obstacle OBS based on the past detection information DTC registered in the history database 200. According to the present embodiment, the predicted position of the obstacle OBS is represented by a distribution rather than a point. The distribution of the predicted position of the obstacle OBS is hereinafter referred to as a “predicted distribution DIST.” The predicted distribution generation unit 130 executes a predicted distribution generation process that generates the predicted distribution DIST of the obstacle OBS based on the history database 200.

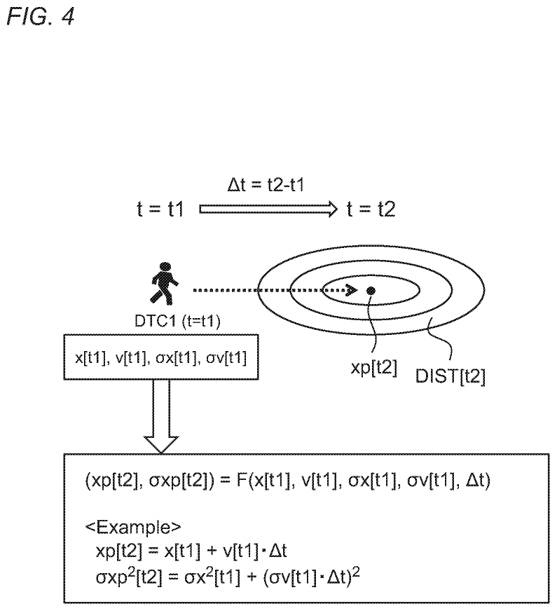

FIG. 4 is a conceptual diagram for explaining an example of the predicted distribution generation process. For convenience sake, in the following description, two times, a “first time t1” and a “second time t2,” are considered. The first time t1 is a time before the second time t2, and the second time t2 is a time after the first time t1. An elapsed time Δt is a period of time from the first time t1 to the second time t2. In the following description, a “target obstacle OBS-T” is the obstacle OBS for which the predicted distribution DIST is generated. For example, the second time t2 is the detection time indicated by the latest detection information DTC, and the target obstacle OBS-T is the obstacle OBS specified by the identification information indicated by the latest detection information DTC. The information indicated by the latest detection information DTC is notified from the tracking unit 120 to the predicted distribution generation unit 130.

First detection information DTC1 is the detection information DTC regarding the target obstacle OBS-T at the first time t1 (the detection time). The first detection information DTC1 includes the detected position x[t1], the detected velocity v[t1], the position error range σx[t1], and the velocity error range σv[t1] of the target obstacle OBS-T at the first time t1. The first detection information DTC1 has already been registered in the history database 200.

The predicted distribution generation unit 130 acquires the first detection information DTC1 from the history database 200. Then, based on the first detection information DTC1, the predicted distribution generation unit 130 predicts the position of the target obstacle OBS-T at the second time t2 to generate a predicted distribution DIST[t2] at the second time t2.

The predicted distribution DIST[t2] at the second time t2 is defined by a combination of a predicted position xp[t2] and a predicted position error range σxp[t2] of the target obstacle OBS-T. The predicted position xp[t2] is a center position of the predicted distribution DIST[t2]. The predicted position error range σxp[t2] is a parameter representing an error range of the predicted position xp[t2] of the target obstacle OBS-T. The predicted position error range σxp[t2] can also be said to be a confidence interval of the predicted position σxp[t] of the target obstacle OBS-T.

The predicted distribution DIST[t2], that is, the predicted position xp[t2] and the predicted position error range σxp[t2] are expressed by a function F of the first detection information DTC1 and the elapsed time Δt(=t2−t1). As an example, FIG. 4 illustrates the function F in a case where it is assumed that the target obstacle OBS-T performs a uniform linear motion. The predicted position xp[t2] is expressed by a function of the detected position x[t1], the detected velocity v[t1], and the elapsed time Δt at the first time t1. The predicted position error range σxp[t2] is expressed by a function of the position error range σx[t1], the velocity error range σv[t1], and the elapsed time Δt at the first time t1.

The prediction distribution generation unit 130 holds a prediction model 135 (see FIG. 2). The prediction model 135 is configured to receive the first detection information DTC1 and the elapsed time Δt and to output the predicted position xp[t2] and the predicted position error range σxp[t2]. That is to say, the prediction model 135 represents the above-described function F. The prediction model 135 may be given by a mathematical expression or a machine learning model. The predicted distribution generation unit 130 is able to generate the predicted distribution DIST[t2] at the second time t2 by inputting the first detection information DTC1 and the elapsed time Δt to the prediction model 135.

The predicted distribution generation unit 130 may correct the predicted distribution DIST[t2] in consideration of the type of the target obstacle OBS-T. For example, it is considered that the vehicle travels along a lane without deviating from the lane. Therefore, when the target obstacle OBS-T is a vehicle, the predicted distribution generation unit 130 may correct the predicted distribution DIST[t2] so that the predicted distribution DIST[t2] is along the lane without deviating from the lane, after the predicted distribution DIST[SL] is generated.

It should be noted that the predicted distribution generation unit 130 may generate the predicted distribution DIST[t2] for a variety of elapsed times Δt by variously changing the first time t1.

### 2-4. Prediction Accuracy Calculation Process (Step S140)

The prediction accuracy calculation unit 140 calculates accuracy of the predicted distribution DIST[t2] of the target obstacle OBS-T.

More specifically, the prediction accuracy calculation unit 140 acquires the predicted distribution DIST[t2] generated by the predicted distribution generation unit 130. In addition, the prediction accuracy calculation unit 140 acquires information on the second detected position x[t2] which is the detected position of the target obstacle OBS-T at the second time t2. The second detected position x[t2] is included in the detection information DTC regarding the target obstacle OBS-T at the second time t2. For example, the prediction accuracy calculation unit 140 acquires the detection information DTC regarding the target obstacle OBS-T at the second time t2 from the tracking unit 120. Then, the prediction accuracy calculation unit 140 calculates the accuracy of the predicted distribution DIST[t2] by comparing the second detected position x[t2] of the target obstacle OBS-T with the predicted distribution DIST[t2].

For example, the prediction accuracy calculation unit 140 calculates a degree of deviation of the second detected position x[t2] from the predicted distribution DIST[t2]. The accuracy of the predicted distribution DIST[t2] is higher as the degree of deviation is smaller. Conversely, the accuracy of the predicted distribution DIST[t2] is lower as the degree of deviation is larger.

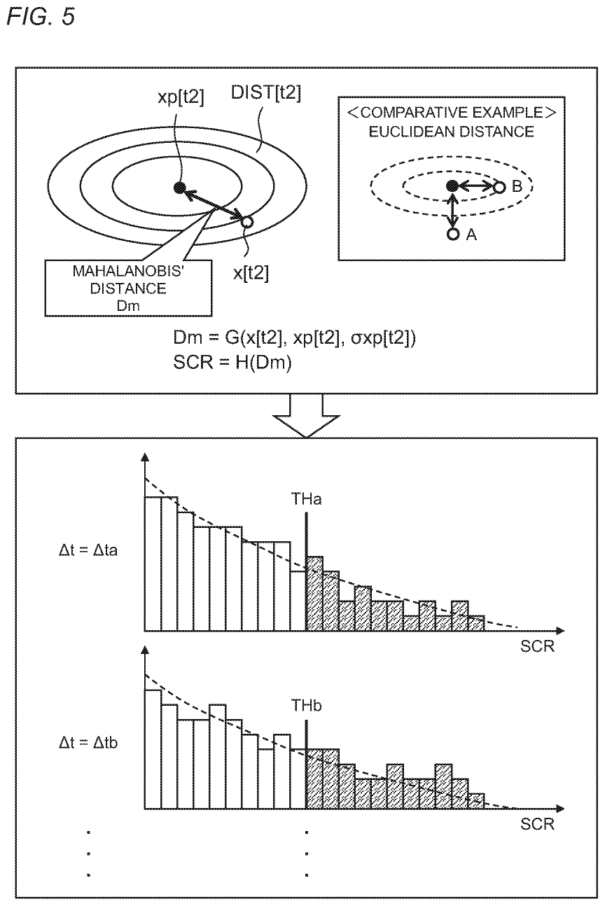

FIG. 5 shows an example of the prediction accuracy calculation process performed by the prediction accuracy calculation unit 140. In the example shown in FIG. 5, the prediction accuracy calculation unit 140 plots the second detected position x[t2] on the predicted distribution DIST[t2]. Then, the prediction accuracy calculation unit 140 calculates a “Mahalanobis' distance Dm” between the center position of the predicted distribution DIST[t2] (that is, the predicted position xp[t2]) and the second detected position x[t2]. The Mahalanobis' distance Dm, which is a distance that takes a shape of the predicted distribution DIST[t2] into account, is different from a simple Euclidean distance that does not take the shape of the predicted distribution DIST[t2] into account. The Mahalanobis' distance Dm is expressed by a function G of the second detected position x[t2], the predicted position xp[t2], and the predicted position error range σxp[t2] of the target obstacle OBS-T. The Mahalanobis' distance Dm can be said to represent the degree of deviation of the second detected position x[t2] from the predicted distribution DIST[t2]. In other words, the Mahalanobis' distance Dm reflects the accuracy of the predicted distribution DIST[t2]. The accuracy of the predicted distribution DIST[t2] is lower as the Mahalanobis' distance Dm is larger.

The prediction accuracy calculation unit 140 acquires an “evaluation value SCR” that is an indicator representing the accuracy of the predicted distribution DIST[t2], based on the Mahalanobis' distance Dm. The evaluation value SCR is calculated so as to increase as the Mahalanobis' distance Dm increases. The Mahalanobis' distance Dm itself may be used as the evaluation value SCR. As another example, a value proportional to the Mahalanobis' distance Dm may be used as the evaluation value SCR. In either case, the degree of deviation of the second detected position x[t2] from the predicted distribution DIST[t2] is larger as the evaluation value SCR is larger. That is, the accuracy of the predicted distribution DIST[t2] is lower as the evaluation value SCR is larger.

It should be noted that when the above-described predicted distribution generation unit 130 generates the predicted distribution DIST[t2] for a variety of elapsed times Δt, the prediction accuracy calculation unit 140 calculates the evaluation values SCR for the variety of elapsed times Δt.

### 2-5. Prediction Abnormality Determination Process (Step S150)

The prediction abnormality determination unit 150 determines whether or not the predicted distribution DIST[t2] of the target obstacle OBS-T is abnormal, that is, whether or not there is an abnormality in the predicted distribution DIST[t2] of the target obstacle OBS-T.

More specifically, the prediction abnormality determination unit 150 acquires information on the accuracy of the predicted distribution DIST[t2] that is calculated by the prediction accuracy calculation unit 140. For example, the prediction abnormality determination unit 150 acquires the evaluation value SCR calculated by the prediction accuracy calculation unit 140. Then, the prediction abnormality determination unit 150 determines whether or not the predicted distribution DIST[t2] is abnormal based on whether or not the accuracy of the predicted distribution DIST[t2] is lower than a predetermined level. When the accuracy of the predicted distribution DIST[t2] is lower than the predetermined level, the prediction abnormality determination unit 150 determines that the predicted distribution DIST[t2] is abnormal.

FIG. 5 also shows an example of the prediction abnormality determination process performed by the prediction abnormality determination unit 150. The prediction abnormality determination unit 150 acquires the evaluation value SCR calculated by the prediction accuracy calculation unit 140. In particular, the prediction abnormality determination unit 150 acquires a variety of evaluation values SCR calculated for the variety of elapsed times Δt. Then, the prediction abnormality determination unit 150 generates a histogram of the evaluation values SCR for each elapsed time Δt. FIG. 5 shows histograms for different elapsed times Δta and Δtb.

In the histogram of each elapsed time Δt (Δta, Δtb), a threshold value Th (Tha, Thb) is set based on a standard deviation σ of a distribution representing the histogram. For example, the threshold value Th is 3σ. The number or a percentage of samples whose evaluation value SCR exceeds the threshold value Th in the histogram of each elapsed time Δt represents a degree of abnormality of the predicted distribution DIST[t2]. The prediction abnormality determination unit 150 acquires, as the degree of abnormality, the number or the percentage of samples whose evaluation value SCR exceeds the threshold value Th in the histogram of each elapsed time Δt.

Then, the prediction abnormality determining unit 150 compares the degree of abnormality with a predetermined abnormality degree threshold. When the degree of abnormality exceeds the predetermined abnormality degree threshold, the prediction abnormality determination unit 150 determines that the predicted distribution DIST[t2] is abnormal. In other words, when the degree of abnormality exceeds the predetermined abnormality degree threshold, the prediction abnormality determination unit 150 determines that the accuracy of the predicted distribution DIST[t2] is below a predetermined level.

### 2-6. Modification Examples

The prediction abnormality determination unit 150 may perform the prediction abnormality determination process that is based on machine learning. For example, an input to a machine learning model is the Mahalanobis' distance Dm described above. Training data (ground truth data) are, for example, presence or absence of an takeover by a safety driver who actually boards the vehicle 1. As another example, the training data are presence or absence of occurrence of the deceleration control exceeding a predetermined deceleration. Training of the machine learning model is performed based on the training data. In an actual operation, the Mahalanobis' distance Dm is input to the machine learning model. The prediction abnormality determination unit 150 compares the output from the machine leaning model with the actual data. When the number of false values exceeds a predetermined value, the prediction abnormality determination unit 150 determines that the predicted distribution DIST[t2] is abnormal.

### 3. Effects

As described above, according to the present embodiment, it is possible to evaluate the prediction accuracy of the future position of the obstacle OBS detected by using the sensor 20 mounted on the vehicle 1.

In particular, according to the present embodiment, the predicted distribution DIST[t2] of the position of the obstacle OBS at the second time t2 after the first time t1 is generated based on the first detection information DTC1 at the first time t1. Then, whether or not the predicted distribution DIST[t2] is abnormal is determined based on the predicted distribution DIST[t2] and the second detected position x[t2] of the obstacle OBS at the second time t2. Considering not only the simple predicted position xp[t2] but also the predicted distribution DIST[t2] makes it possible to evaluate the prediction accuracy with higher accuracy.

As a comparative example, a case where a simple Euclidean distance without considering the predicted distribution DIST[t2] is used as an index representing the prediction accuracy will be considered (see FIG. 5). As shown in the comparative example in FIG. 5, an Euclidean distance from the predicted position xp[t2] to a point A and an Euclidean distance from the predicted position xp[t2] to a point B are equal to each other. However, the degree of deviation from the predicted distribution DIST[t2] is completely different between the point A and the point B. Therefore, if the simple Euclidean distance is used as the index representing the prediction accuracy, the prediction accuracy is erroneously determined to be equivalent even though the actual degree of deviation is completely different from each other.

On the other hand, according to the present embodiment, the Mahalanobis' distance Dm that takes the predicted distribution DIST[t2] into consideration is used as the index representing the prediction accuracy. It is thus possible to evaluate the prediction accuracy with higher accuracy. In other words, the validity of the evaluation of the prediction accuracy is further improved.

### 4. Application Example

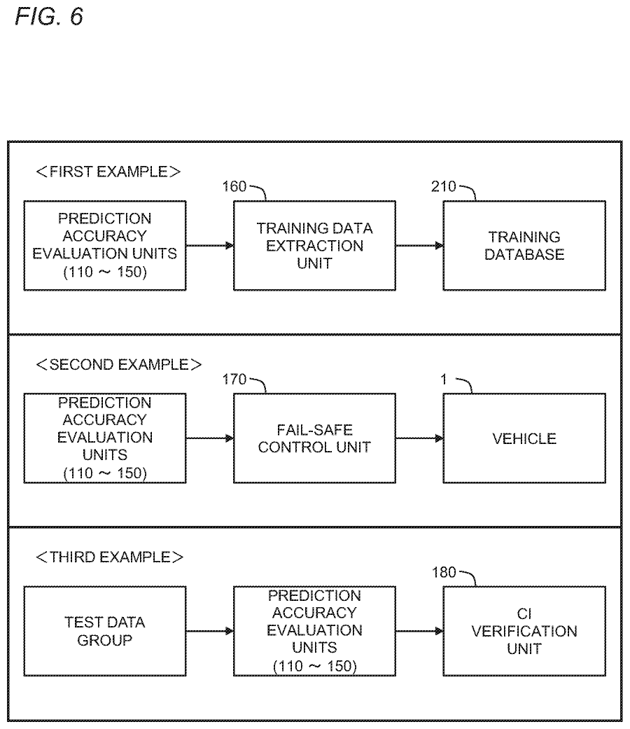

FIG. 6 is a block diagram for explaining application examples of the prediction accuracy evaluation system 100 according to the present embodiment.

In a first example, the prediction accuracy evaluation system 100 includes a training data extraction unit 160 in addition to the prediction accuracy evaluation units (110 to 150). The training data extraction unit 160 extracts log sensor datasets before and after a scene in which it is determined that the predicted distribution DIST[t2] is abnormal. Then, the training data extraction unit 160 stores the extracted log sensor data and the like in a training database 210. The stored log sensor dataset is used as a training dataset for reinforcement learning of the prediction model 135.

In a second example, the prediction accuracy evaluation system 100 includes a fail-safe control unit 170 in addition to the prediction accuracy evaluation units (110 to 150). When it is determined that the predicted distribution DIST[t2] is abnormal, the fail-safe control unit 170 instructs the in-vehicle system 10 to execute a fail-safe control. For example, the fail-safe control is a deceleration control for decelerating the vehicle 1. As another example, the fail-safe control is a safety stop control for stopping the vehicle 1 at a safe position. The deceleration control and the safety stop control may be switched according to the degree of abnormality of the predicted distribution DIST[t2]. The fail-safe control ensures the safety of the vehicle 1.

In a third example, the prediction accuracy evaluation system 100 is used for verification of continuous integration (CI) related to the prediction model 135. The prediction accuracy evaluation units executes the prediction accuracy evaluation process based on a test data group. A CI verification unit 180 automatically verifies the prediction model 135 based on the presence or absence of the abnormality in the predicted distribution DIST[t2].

What is claimed is:

1. A prediction accuracy evaluation method executed by a computer,
the prediction accuracy evaluation method comprising:
acquiring detection information indicating a detected position, a detected velocity, an error range of the detected position, and an error range of the detected velocity of an obstacle detected by using a sensor mounted on a moving body;
a predicted distribution generation process that generates a predicted distribution of a position of the obstacle at a second time later than a first time, based on first detection information that is the detection information at the first time; and
a prediction abnormality determination process that determines whether or not the predicted distribution is abnormal based on the predicted distribution and a second detected position that is the detected position of the obstacle at the second time.

2. The prediction accuracy evaluation method according to claim 1, further comprising a prediction accuracy calculation process that calculates accuracy of the predicted distribution by comparing the second detected position with the predicted distribution, wherein
the prediction abnormality determination process includes determining that the predicted distribution is abnormal when the accuracy of the predicted distribution is lower than a predetermined level.

3. The prediction accuracy evaluation method according to claim 2, wherein
the prediction accuracy calculation process includes:
calculating a Mahalanobis' distance between a center position of the predicted distribution and the second detected position; and
acquiring an evaluation value that increases as the Mahalanobis' distance increases, as an index indicating the accuracy of the predicted distribution, and
the prediction abnormality determination process is performed based on the evaluation value.

4. The prediction accuracy evaluation method according to claim 3, wherein
the prediction abnormality determination process includes:
generating a histogram of the evaluation value for each elapsed time from the first time to the second time;
acquiring, as a degree of abnormality, a number or a percentage of samples whose evaluation value exceeds a threshold value in the histogram; and
determining that the predicted distribution is abnormal when the degree of abnormality exceeds an abnormality degree threshold.

5. A prediction accuracy evaluation system comprising processing circuitry, wherein
the processing circuitry is configured to execute:
acquiring detection information indicating a detected position, a detected velocity, an error range of the detected position, and an error range of the detected velocity of an obstacle detected by using a sensor mounted on a moving body;
a predicted distribution generation process that generates a predicted distribution of a position of the obstacle at a second time later than a first time, based on first detection information that is the detection information at the first time; and
a prediction abnormality determination process that determines whether or not the predicted distribution is abnormal based on the predicted distribution and a second detected position that is the detected position of the obstacle at the second time.
